(19) United States
(12) Patent Application Publication
(10) Pub. No.: US 2010/0166985 A1
(43) Pub. Date: Jul. 1, 2010

(54) AQUEOUS DISPERSIONS OF (METH)ACRYLIC ESTERS OF POLYMERS COMPRISING N-HYDROXYALKYLATED LACTAM UNITS AND USE OF (METH)ACRYLIC ESTERS OF POLYMERS COMPRISING N-HYDROXYALKYLATED LACTAM UNITS

(75) Inventors: Andreas Brockmeyer, Bickenbach (DE); Roland Ettl, Altusshiem (DE); Yvonne Dieckmann, Hassloch (DE); Maximilian Angel, Schifferstadt (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/597,175

(22) PCT Filed: May 15, 2008
(86) PCT No.: PCT/EP08/55986

§ 371 Date: Oct. 23, 2009

(30) Foreign Application Priority Data
May 18, 2007 (EP) 07108448.7

(51) Int. Cl. B41M 5/00; C08L 77/02; C08L 3/00

(52) U.S. Cl. 428/32.1; 524/548; 524/47

(57) ABSTRACT

Aqueous dispersions of (meth)acrylic esters of polymers comprising N-hydroxyalkylated lactam units and obtainable by free-radically initiated emulsion polymerization, wherein monomers copolymerized are
(a) styrene, acrylonitrile, methacrylonitrile and/or methyl methacrylate,
(b) at least one C₁ to C₁₈ alkyl acrylate and/or at least one C₂ to C₁₈ alkyl methacrylate,
(c) at least one acrylic ester of an N-hydroxyalkylated lactam and/or at least one methacrylic ester of an N-hydroxyalkylated lactam, and
(d) if appropriate, other ethylenically unsaturated monomers,
   and use of these aqueous dispersions and/or of polymers which comprise in copolymerized form at least one acrylic ester of an N-hydroxyalkylated lactam and/or at least one methacrylic ester of an N-hydroxyalkylated lactam for treating the surface of paper and of paper products, and also the inkjet papers obtainable accordingly.

The invention relates to aqueous dispersions of (meth)acrylic esters of polymers comprising N-hydroxyalkylated lactam units, to processes for preparing them, and to the use of (meth)acrylic esters of polymers comprising N-hydroxyalkylated lactam units for treating paper.

DE-A 20 48 312 discloses polymers which comprise lactam groups and are composed wholly or partly of monomer units of the formula

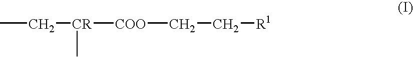

in which R is hydrogen or a methyl group and R¹ is a cycloaliphatic lactam group. The corresponding monomers comprising lactam groups are prepared by reacting N-hydroxyalkylated lactams with acrylic or methacrylic esters. They can be copolymerized for example with ethylene, styrene, butadiene, acrylic esters, methacrylic esters, acrylamide, methacrylamide, acrylonitrile, methacrylonitrile or vinyl esters. The polymerization may be carried out in bulk or in a diluent in accordance with the typical methods of suspension, solution or emulsion polymerization. Applications for which the polymers are suitable include the finishing of paper.

In order for a paper to be printable it must at least be sized or coated with a papercoating slip. In the case of inkjet printing methods in particular, where droplets of a usually aqueous solution of ink are sprayed from a nozzle onto a recording material, the requirements imposed on the quality of the paper are exacting. Given that the printing inks used are water-soluble or readily water-dispersible, the prints obtainable by the inkjet printing method are sensitive to water. In order to obtain water-resistant prints by this printing method, the papers used for printing are those whose printability has been enhanced as a result, for example, of the treatment of the paper surface with aqueous solutions of a metal salt or with polyallylamines; cf. EP-A 0 739 743.

EP-A 0 257 412 discloses the use of polymer dispersions based on acrylic esters and acrylonitrile for the surface treatment of paper. This treatment produces water repellency and enhances the inkjet printability of the paper.

WO 2004/096566 discloses a method of improving the printability of paper and paper products when printed by means of the inkjet printing method, using cationic polymers having a charge density of at least 3 meq/g as the sole treatment agent, in aqueous solution, and applying them to the surface of paper or of paper products in an amount of 0.05 to 5 g/m². Examples of suitable cationic polymers include polyallylamines, polyamidoamines, polyamines, polyamidoamine-epichlorohydrin resins, polyvinylamines, and partly hydrolyzed polyvinylformamides.

Known from U.S. Pat. No. 6,699,536 is an inkjet recording material which has been coated with inorganic particles, polyvinyl alcohol, at least two cationic polymers having a quaternary ammonium salt group in the molecule, and a compound comprising zirconium or aluminum ions. The recording material in question preferably comprises paper products which have been coated on either side with a polymeric film, of polyethylene or polypropylene, for example, or else uncoated paper products.

Also known as inkjet recording materials are papers laminated on either side with a transparent film of polyethylene or polyester, for example. Thereupon a layer is applied which absorbs ink. It is composed of inorganic particles, a hydrophilic binder such as polyvinyl alcohol or polyvinylpyrrolidone, and an inorganic curing agent such as boric acid or an organic curing agent such as a polyisocyanate; cf. U.S. Pat. No. 6,582,802.

U.S. Pat. No. 6,632,487, furthermore, discloses inkjet recording materials which are produced, for example, by powder-coating paper with a finely divided resin comprising inorganic particles.

Iskander et al. (Polymer, 39 (17), 4165-4169, 1998) describe the synthesis and polymerization of pyrrolidone-containing methacrylate monomers. The 1-(n-alkyl-2-pyrrolidone)methacrylates described therein possess the general structure

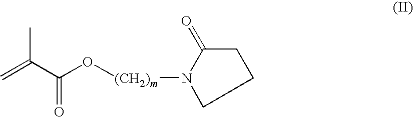

in which m=2, 3, 4 or 6.

Also known is a catalytic process for preparing (meth)acrylates of N-hydroxyalkylated lactams; cf. WO 2007/051738. These compounds are suitable monomers or comonomers in the preparation of poly(meth)acrylates and dispersions for applications in the paper segment. Further catalytic processes for preparing (meth)acrylic esters of N-hydroxyalkylated lactams are known from the earlier EP applications 07 102 481.4 and 07 102 484.8.

It is an object of the invention to provide new materials which are especially suitable for enhancing the inkjet printability of paper, and also to specify further materials for this application.

This object is achieved in accordance with the invention by aqueous dispersions of (meth)acrylic esters of polymers comprising N-hydroxyalkylated lactam units and obtainable by free-radically initiated emulsion polymerization of (meth)acrylic esters of N-hydroxyalkylated lactams and other ethylenically unsaturated monomers, wherein monomers copolymerized are
(a) styrene, acrylonitrile, methacrylonitrile and/or methyl methacrylate,
(b) at least one C₁ to C₁₈ alkyl acrylate and/or at least one C₂ to C₁₈ alkyl methacrylate,
(c) at least one acrylic ester of an N-hydroxyalkylated lactam and/or at least one methacrylic ester of an N-hydroxyalkylated lactam, and
(d) if appropriate, other ethylenically unsaturated monomers.

Monomers of group (a) are styrene, acrylonitrile, methacrylonitrile, and methyl methacrylate. The monomers of this group can be used in the emulsion polymerization either on their own or in a mixture, e.g., styrene and acrylonitrile, or mixtures of styrene and methyl methacrylate. The amounts used in the emulsion polymerization are for example 1% to 80% by weight, preferably 20% to 70% by weight, based on the sum of the monomers (a) to (d).

Suitable group (b) monomers include acrylic esters of monohydric alcohols having 1 to 18, preferably 1 to 10, C atoms and methacrylic esters of monohydric alcohols having 2 to 18, preferably 2 to 10, C atoms in the molecule. Examples of such monomers are methyl acrylate, ethyl acrylate, n-propyl acrylate, isopropyl acrylate, n-butyl acrylate, isobutyl acrylate, tert-butyl acrylate, n-pentyl acrylate, neopentyl acrylate, cyclopentyl acrylate, cyclohexyl acrylate, n-hexyl acrylate, 2-ethylhexyl acrylate, 3-propylheptyl acrylate, decyl acrylate, dodecyl acrylate, lauryl acrylate, palmityl acrylate, stearyl acrylate, ethyl methacrylate, n-propyl methacrylate, isopropyl methacrylate, n-butyl methacrylate, isobutyl methacrylate, tert-butyl methacrylate, n-pentyl methacrylate, neopentyl methacrylate, cyclopentyl methacrylate, cyclohexyl methacrylate, n-hexyl methacrylate, 2-ethylhexyl methacrylate, n-octyl methacrylate, decyl methacrylate, dodecyl methacrylate, lauryl methacrylate, palmityl methacrylate, and stearyl methacrylate.

A monomer used with particular preference is n-butyl acrylate. The group (b) monomers are used in the polymerization in an amount for example of 1% to 70% by weight, preferably 10% to 60% by weight, based on the sum of the monomers (a) to (d).

Monomers of group (c) are acrylic and methacrylic esters of N-hydroxyalkylated lactams. They are known, for example, from the prior-art document DE-A 20 48 321. They are derived, for example, from cyclic N-hydroxyalkylated lactams (L) which have been esterified with acrylic acid or methacrylic acid, the lactams being describable with the following formula (III):

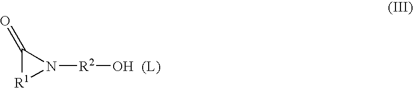

in which
R¹ is C₁-C₅ alkylene or a C₂-C₂₀ alkylene interrupted by one or more oxygen and/or sulfur atoms and/or by one or more substituted or unsubstituted imino groups and/or by one or more cycloalkyl, —(CO)—, —O(CO)O—, —(NH)(CO)O—, —O(CO)(NH)—, —O(CO)— or —(CO)O— groups, it being possible for each of the stated radicals to be substituted by aryl, alkyl, aryloxy, alkyloxy, heteroatoms and/or heterocycles,
with the proviso that R¹ may not have any atom other than a carbon atom directly adjacent to the lactam carbonyl group,
R² is C₁-C₂₀ alkylene, C₅-C₁₂ cycloalkylene, C₆-C₁₂ arylene or C₂-C₂₀ alkylene interrupted by one or more oxygen and/or sulfur atoms and/or by one or more substituted or unsubstituted imino groups and/or by one or more cycloalkyl, —(CO)—, —O(CO)O—, —(NH)(CO)O—, —O(CO)(NH)—, —O(O)— or —(CO)—O— groups, it being possible for each of the stated radicals to be substituted by aryl, alkyl, aryloxy, alkyloxy, heteroatoms and/or heterocycles, or
R²—OH is a group of the formula —[Xᵢ]ₖ—H,
k is a number from 1 to 50, and
X, for each i=1 to k can be selected independently of one another from the group consisting of —CH₂—CH₂—O—, —CH₂—CH₂—N(H)—, —CH₂—CH₂—CH₂—N(H)—, —CH₂—CH(NH₂)—, —CH₂—CH(NHCHO)—, —CH₂—CH(CH₃)—O—, —CH(CH₃)—CH₂—O—, —CH₂—C(CH₃)₂—O—, —C(CH₃)₂—CH₂—O—, —CH₂—CH₂—CH₂—O—, —CH₂—CH₂—CH₂—CH₂—O—, —CH₂—CHVin-O—, —CHVin-CH₂—O—, —CH₂—CHPh—O—, and CHPh—CH₂—O—, in which Ph is phenyl and Vin is vinyl.

Examples of the compounds (L) are N-(2-hydroxyethyl)pyrrolidone, N-(2-hydroxypropyl)pyrrolidone, N-(2′-(2-hydroxyethoxy)ethyl)pyrrolidone, N-(2-hydroxyethyl)caprolactam, N-(2-hydroxypropyl)caprolactam, and N-(2′-(2-hydroxyethoxy)ethyl)caprolactam, preference being given to N-(2-hydroxyethyl)pyrrolidone and N-(2-hydroxypropyl)pyrrolidone. Particular preference is given to N-(2-hydroxyethyl)pyrrolidone (IIIa), which by means for example of transesterification with methyl methacrylate as per the scheme below is converted into pyrrolidonoethyl methacrylate (IV), i.e., into a monomer of group (c):

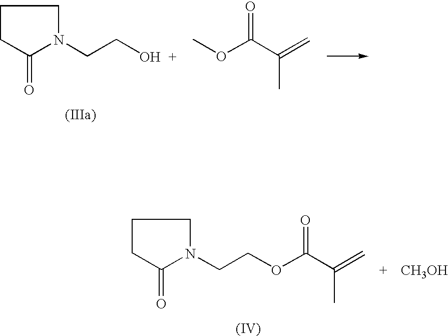

The other monomers of group (c) can be prepared analogously from a compound of the formula III and a methacrylic or acrylic ester. Pyrrolidonoethyl acrylate and/or pyrrolidonoethyl methacrylate are the preferentially suitable group (c) monomers, and are employed in the emulsion polymerization, on their own or in a mixture with one another, in an amount of for example 1% to 50%, preferably 2% to 35%, and in particular of 5% to 25% by weight, based on the sum of the monomers (a) to (d).

Suitable group (d) monomers include (i) monoethylenically unsaturated monomers other than the monomers of groups (a), (b), and (c), and (ii) crosslinkers, i.e., compounds which have at least two ethylenically unsaturated double bonds in the molecule.

Examples of monomers (i) are acrylamide, methacrylamide, monoethylenically unsaturated acids such as acrylic acid, methacrylic acid, crotonic acid, maleic acid, fumaric acid, itaconic acid, vinyllactic acid, vinylacetic acid, vinylsulfonic acid, 2-acrylamido-2-methylpropanesulfonic acid, 2-acryloyloxyethanesulfonic acid, 2-methacryloyloxyethanesulfonic acid, 3-acryloyloxy- and 3-methacryloyloxypropane-sulfonic acid, vinylbenzenesulfonic acid, vinylphosphonic acid, and dimethyl vinylphosphonate. Acid anhydrides of ethylenically unsaturated acids, such as maleic anhydride, are also suitable monomers (d). The ethylenically unsaturated acids can be used in unneutralized form, in a form neutralized partly or fully with an alkali-metal base or alkaline-earth metal base, ammonia or amines, in the emulsion polymerization.

Further monomers (i) of group (d) are hydroxyalkyl esters of α,β-ethylenically unsaturated C₃-C₈ monocarboxylic acids and C₄-C₈ dicarboxylic acids, more particularly 2-hydroxyethyl acrylate, 2-hydroxyethyl methacrylate, 2- and 3-hydroxypropyl acrylate, 2- and 3-hydroxypropyl methacrylate, monoesters of the aforementioned monoethylenically unsaturated monocarboxylic and dicarboxylic acids with C₂-C₄ polyalkylene glycols, more particularly the monoesters of these carboxylic acids with polyethylene glycol or alkyl-polyethylene glycols, the (alkyl-)polyethylene glycol radical typically having a molecular weight in the range from 100 to 3000. These monomers further include N-vinyl amides such as N-vinylformamide, N-vinylpyrrolidone, N-vinylimidazole, and N-vinylcaprolactam, and also ethylene, propylene, but-1-ene, but-2-ene, and hex-1-ene.

The monomers (i) of group (d) further include monoethylenically unsaturated monomers which have at least one cationic group and/or at least one amino group which can be protonated in the aqueous medium, one quaternary ammonium group, one protonatable imino group or one quaternized imino group. Examples of monomers having a protonatable imino group are N-vinylimidazole and N-vinylpyridines. Examples of monomers having a quaternized imino group are N-alkylvinylpyridinium salts and N-alkyl-N′-vinylimidazolinium salts such as N-methyl-N′-vinylimidazolinium chloride or methosulfate. Particularly preferred among these monomers are the monomers of the general formula V

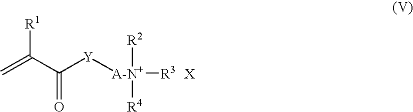

in which
R¹ is hydrogen or C₁-C₄ alkyl, more particularly hydrogen or methyl,
R² and R³ independently of one another are C₁-C₄ alkyl, more particularly methyl, and
R⁴ is hydrogen or C₁-C₄ alkyl, more particularly hydrogen or methyl,
Y is oxygen, NH or NR⁵ with R⁵═C₁-C₄ alkyl,
A is C₂-C₈ alkylene, e.g., 1,2-ethanediyl, 1,2- or 1,3-propanediyl, 1,4-butanediyl or 2-methyl-1,2-propanediyl, which if appropriate is interrupted by 1, 2 or 3 nonadjacent oxygen atoms, and
X⁻ is one anion equivalent, e.g., Cl⁻, HSO₄⁻, ½ SO₄²⁻ or CH₃OSO₃⁻ etc.

Examples of monomers of this kind are 2-(N,N-dimethylamino)ethyl acrylate, 2-(N,N-dimethylamino)ethyl methacrylate, 2-(N,N-dimethylamino)ethylacrylamide, 3-(N,N-dimethylamino)propylacrylamide, 3-(N,N-dimethylamino)propylmethacrylamide, 2-(N,N-dimethylamino)ethylmethacrylamide, 2-(N,N,N-trimethylammonio)ethyl acrylate chloride, 2-(N,N,N-trimethylammonio)ethyl methacrylate chloride, 2-(N,N,N-trimethylammonio)ethylmethacrylamide chloride, 3-(N,N,N-trimethylammonio)propylacrylamide chloride, 3-(N,N,N-trimethylammonio)propylmethacrylamide chloride, 2-(N,N,N-trimethylammonio)ethylacrylamide chloride, and also the corresponding methosulfates and sulfates.

In the emulsion polymerization the monomers (i) of group (d) are used in an amount of for example 0% to 20% by weight, based on the sum of the monomers (a) to (d). If they are used to modify the copolymers, the amounts preferentially employed are 1% to 10% by weight, based on the sum of the monomers (a) to (d).

The polymers may if appropriate comprise in copolymerized form at least one monomer (ii) of group (d), which can typically be employed as crosslinkers in an emulsion polymerization. The crosslinkers may be used as a sole monomer of group (d) or else together with a monomer (i) of group (d) in the emulsion polymerization. However, the proportion of monomers (ii) which have two or more ethylenically unsaturated double bonds typically accounts for not more than 10%, usually not more than 5%, in particular not more than 2%, e.g., 0.01% to 2%, and in particular 0.05% to 1.5% by weight, based on the total amount of the monomers.

Examples of crosslinkers are butanediol diacrylate, butanediol dimethacrylate, hexanediol diacrylate, hexanediol dimethacrylate, glycol diacrylate, glycol dimethacrylate, trimethylolpropane triacrylate, trimethylolpropane trimethacrylate, pentaerythritol triacrylate, pentaerythritol tetraacrylate, diacrylates and dimethacrylates of alkoxylated dihydric alcohols, divinylurea and/or conjugated diolefins such as butadiene or isoprene.

Depending on intended application, the monomers (ii) of group (d) may also comprise what are called functional monomers, i.e., monomers which as well as a polymerizable C═C double bond also have a reactive functional group, such as an oxirane group, a reactive carbonyl group, say an acetoacetyl group, or an isocyanate group, an N-hydroxymethyl group, an N-alkoxymethyl group, a trialkylsilyl group or a trialkoxysilyl group, or another group reactive toward nucleophiles.

The monomers are polymerized by the method of an emulsion polymerization, i.e., the monomers to be polymerized are present in the form of an aqueous emulsion in the polymerization mixture. The monomer emulsions are stabilized using a dispersion stabilizer, examples of which are surfactants, especially anionic surfactants, water-soluble starch, anionic or cationic starch, and protective colloids. The amount of dispersion stabilizer is for example 0.1% to 30% by weight, preferably 0.5% to 20% by weight, based on the monomers used in the polymerization.

The surfactants suitable as dispersion stabilizers may for example be cationic, anionic, amphoteric or nonionic. It is possible to use one surfactant from a single group of the specified surfactants, or to use mixtures of surfactants which are compatible with one another, i.e., which in aqueous medium are stable alongside one another and do not form precipitates; examples include mixtures of at least one nonionic and at least one anionic surfactant, mixtures of at least one nonionic and at least one cationic surfactant, mixtures of at least two cationic surfactants, mixtures of at least two anionic surfactants, or else mixtures of at least two nonionic surfactants. Apart from a surfactant it is additionally possible as dispersion stabilizer to use a protective colloid and/or a dispersant. Suitability is possessed for example by mixtures of at least one surfactant and at least one dispersant, or mixtures of at least one surfactant, at least one dispersant, and at least one protective colloid. Preferred mixtures are those comprising two or more dispersion stabilizers.

Examples of suitable surfactants include all surface-active agents. Examples of suitable nonionic surface-active compounds are ethoxylated mono-, di- and tri-alkylphenols (degree of ethoxylation: 3 to 50, alkyl radical: C₃-C₁₂) and also ethoxylated fatty alcohols (degree of ethoxylation: 3 to 80; alkyl radical: C₈-C₃₆). Examples thereof are the Lutensol® brands from BASF AG or the Triton® brands from Union Carbide. Particular preference is given to ethoxylated linear fatty alcohols of the general formula

n-CₓH₂ₓ₊₁—O(CH₂CH₂O)_{y}—H,

where indices x are integers in the range from 10 to 24, preferably in the range from 12 to 20. The variable y stands preferably for integers in the range from 5 to 50, more preferably 8 to 40. Ethoxylated linear fatty alcohols typically take the form of a mixture of different ethoxylated fatty alcohols with different degrees of ethoxylation. For the purposes of the present invention the variable y stands for the average value (numerical average). Further suitable nonionic surface-active substances are copolymers, more particularly block copolymers of ethylene oxide and at least one C₃-C₁₀ alkylene oxide, examples being triblock copolymers of the formula

RO(CH₂CH₂O)_{y1}—(BO)_{y2}-(A-O)ₘ—(B′O)_{y3}—(CH₂CH₂O)_{y4}R′.

in which m is 0 or 1, A is a radical derived from an aliphatic, cycloaliphatic or aromatic diol, e.g., ethane-1,2-diyl, propane-1,3-diyl, butane-1,4-diyl, cyclohexane-1,4-diyl, cyclohexane-1,2-diyl or bis(cyclohexyl)methane-4,4′-diyl, B and B′ independently of one another are propane-1,2-diyl, butane-1,2-diyl or phenylethanyl, y1, y2, and y3 independently of one another are a number from 2 to 100, the sum of y1+y2+y3+y4 preferably being in the range from 20 to 400, corresponding to a number-average molecular weight in the range from 1000 to 20 000. Preferably A is ethane-1,2-diyl, propane-1,3-diyl or butane-1,4-diyl. B is preferably propane-1,2-diyl.

Suitable surface-active substances apart from the nonionic surfactants are anionic and cationic surfactants. They can be used alone or as a mixture. This, however, is subject to the proviso that they are compatible with one another. This proviso applies, for example, to mixtures from one class of compound in each case, and also to mixtures of nonionic and anionic surfactants and mixtures of nonionic and cationic surfactants. Examples of suitable anionic surface-active agents are sodium lauryl sulfate, sodium dodecyl sulfate, sodium hexadecyl sulfate, and sodium dioctylsulfosuccinate.

Examples of cationic surfactants are quaternary alkylammonium salts, alkylbenzylammonium salts, such as dimethyl-C₁₂ to C₁₈ alkylbenzylammonium chlorides, primary, secondary and tertiary fatty amine salts, quaternary amidoamine compounds, alkylpyridinium salts, alkylimidazolinium salts, and alkyloxazolinium salts.

Particular preference is given to anionic surfactants, such as, for example, alcohols esterified with sulfuric acid (and alkoxylated if appropriate), which are usually used in a form in which they have been neutralized with aqueous alkali metal hydroxide solution. Examples of other typical emulsifiers include sodium alkylsulfonates, sodium alkyl sulfates such as sodium lauryl sulfate, sodium dodecylbenzenesulfonate, and sulfosuccinic esters. As anionic emulsifiers it is also possible, moreover, to use esters of phosphoric acid or of phosphorous acid, and also aliphatic or aromatic carboxylic acids. Typical emulsifiers are described in detail in the literature; see for example M. Ash, I. Ash, Handbook of Industrial Surfactants, Third Edition, Synapse Information Resources Inc. The amount of surfactants used to stabilize the monomer emulsion is for example 0.1% to 5%, preferably 0.5% to 2% by weight, based on the monomers employed in total.

To stabilize an emulsion it is also possible to operate for example in the presence of a surfactant and of at least one dispersant and/or of at least one protective colloid. Examples of frequently used dispersants are condensates of naphthalenesulfonic acid and formaldehyde, condensates of a salt of naphthalenesulfonic acid or ligninsulfonic acid and/or salts thereof. Suitable salts of naphthalenesulfonic acid and of ligninsulfonic acid are preferably the products fully or partially neutralized with aqueous sodium or potassium hydroxide solution, ammonia or calcium hydroxide. As dispersants it is also possible, though, to use amphiphilic polymers or nanoparticles of water-insoluble organic polymers or of water-insoluble inorganic compounds (Pickering effect). Examples of stabilizers of this kind are nanoscale silicon dioxide and nanoscale aluminum oxide.

Amphiphilic polymers are also suitable dispersants. They have an average molar mass M_{w}, for example, of 1000 to 100 000. They are used in combination with a surfactant as dispersion stabilizer. Examples of amphiphilic polymers are copolymers which comprise units of
(i) hydrophobic monoethylenically unsaturated monomers and
(ii) monoethylenically unsaturated carboxylic acids, monoethylenically unsaturated sulfonic acids, monoethylenically unsaturated phosphonic acids or mixtures thereof and/or basic monomers.

Examples of suitable hydrophobic monoethylenically unsaturated monomers for preparing the amphiphilic polymers are
(i) styrene, methylstyrene, ethylstyrene, acrylonitrile, methacrylonitrile, C₂ to C₁₈ olefins, esters of monoethylenically unsaturated C₃ to C₅ carboxylic acids and monohydric alcohols, vinyl alkyl ethers, vinyl esters or mixtures thereof. From this group of monomers it is preferred to use isobutene, diisobutene, styrene, and acrylic esters such as ethyl acrylate, isopropyl acrylate, n-butyl acrylate, and sec-butyl acrylate.

The hydrophilic monomers the amphiphilic copolymers comprise are preferably
(ii) acrylic acid, methacrylic acid, maleic acid, maleic anhydride, itaconic acid, vinylsulfonic acid, 2-acrylamidomethylpropanesulfonic acid, 3-acrylamido-propanesulfonic acid, 3-sulfopropyl acrylate, 3-sulfopropyl methacrylate, styrenesulfonic acid, vinylphosphonic acid or mixtures thereof, in copolymerized form. The acidic monomers can be in the form of the free acids or in partially or fully neutralized form.

Further suitable hydrophilic monomers are basic monomers. They can be polymerized with the hydrophobic monomers (i) alone or else in a mixture with aforementioned acidic monomers. If mixtures of basic and acidic monomers are employed, the products are amphoteric copolymers which, depending on the molar ratio of the acidic to basic monomers copolymerized, are anionically or cationically charged.

Basic monomers are, for example, di-C₁ to C₂ alkylamino-C₂ to C₄ alkyl(meth)acrylates or diallyldimethylammonium chloride. The basic monomers may take the form of free bases, of salts with organic or inorganic acids, or a form in which they are quaternized with alkyl halides. The salt formation or quaternization process in the course of which the basic monomers become cationic may have taken place partly or completely. Examples of such compounds are dimethylaminoethyl methacrylate, diethylaminoethyl methacrylate, dimethylaminoethyl acrylate, diethylaminoethyl acrylate, dimethylamino-propyl methacrylate, dimethylaminopropyl acrylate, diethylaminopropyl methacrylate, diethylaminopropyl acrylate and/or dimethylaminoethylacrylamide, dimethylaminoethylmethacrylamide, dimethylaminopropylacrylamide, dimethylaminopropylmethacrylamide and/or diallyldimethylammonium chloride.

Where the amphiphilic copolymers are not sufficiently water-soluble in the form of the free acid, they are used in the form of water-soluble salts; use is made for example of the corresponding alkali metal, alkaline earth metal, and ammonium salts. These salts are prepared, for example, by partial or full neutralization of the free acid groups of the amphiphilic copolymers with bases, examples of those used for the neutralization being aqueous sodium or potassium hydroxide solution, magnesium oxide, ammonia or amines such as triethanolamine, ethanolamine, morpholine, triethylamine or butylamine. The acid groups of the amphiphilic copolymers are preferably neutralized using ammonia or aqueous sodium hydroxide solution. The water-solubility of basic monomers or of copolymers which comprise such monomers in copolymerized form can be increased in contrast by partial or complete neutralization with a mineral acid such as hydrochloric or sulfuric acid or by addition of an organic acid such as acetic or p-toluenesulfonic acid. The molar mass of the amphiphilic copolymers is for example 1000 to 100 000 and is preferably in the range from 1500 to 10 000. The acid numbers of the amphiphilic copolymers are for example 50 to 500, preferably 150 to 350 mg KOH/g polymer.

Preferred dispersants are those amphiphilic copolymers which comprise in copolymerized form
(i) 95% to 45% by weight of isobutene, diisobutene, styrene or mixtures thereof and
(ii) 5% to 55% by weight of acrylic acid, methacrylic acid, maleic acid, monoesters of maleic acid, or mixtures thereof,
   with the copolymers mostly used as dispersants being copolymers comprising in copolymerized form
(i) 45% to 80% by weight of styrene,
(ii) 55% to 20% by weight of acrylic acid, and if appropriate
(iii) further monomers in addition.

The copolymers may if appropriate comprise as further monomers (iii), in copolymerized form, units of maleic monoesters. Copolymers of this kind are obtainable, for example, by copolymerizing copolymers from styrene, diisobutene or isobutene or mixtures thereof of maleic anhydride in the absence of water, and, following the polymerization, reacting the copolymers with alcohols, using 5 to 50 mol % of a monohydric alcohol per mole of anhydride groups in the copolymer. Examples of suitable alcohols are methanol, ethanol, n-propanol, isopropanol, n-butanol, isobutanol, and tert-butanol. An alternative option is to react the anhydride groups of the copolymers with polyhydric alcohols such as glycol or glycerol. In that case the reaction, however, is taken only to the point where just one OH group of the polyhydric alcohol reacts with the anhydride group. Where the anhydride groups of the copolymers are not fully reacted with alcohols, the ring opening of the anhydride groups that have not reacted with alcohols is accomplished by addition of water.

Other suitable dispersion stabilizers are mixtures of at least one surfactant and, for example, commercially customary polymers of monoethylenically unsaturated acids, and also graft polymers of N-vinylformamide on polyalkylene glycols, which are described for example in WO 96/34903. The vinylformamide units grafted on may if appropriate have been hydrolyzed to form vinylamine units. The fraction of grafted-on vinylformamide units is preferably 20% to 40% by weight, based on polyalkylene glycol. Preference is given to using polyethylene glycols with molar masses of 2000 to 10 000.

As dispersion stabilizers it is additionally possible to use mixtures of at least one surfactant and zwitterionic polyalkylenepolyamines and/or zwitterionic polyethylenimines. Compounds of this kind are known from EPB 0 112 592, for example. They are obtainable by, for example, first alkoxylating a polyalkylene-polyamine or polyethylenimine, with ethylene oxide, propylene oxide and/or butylene oxide, for example, and then quaternizing the alkoxylation products, with methyl bromide or dimethyl sulfate, for example, and subsequently sulfating the quaternized, alkoxylated products using chlorosulfonic acid or sulfur trioxide. The molar mass of the zwitterionic polyalkylenepolyamines is for example 1000 to 9000, preferably 1500 to 7500. The zwitterionic polyethylenimines preferably have molar masses in the range from 1500 to 7500 daltons.

As a dispersion stabilizer for the emulsion polymerization it is also possible to use a surfactant and at least one protective colloid, which is selected, for example, from the group consisting of polyvinyl alcohols, polyvinylpyrrolidones, polyacrylic acids, polyalkylene glycols, polyalkylene glycols end group-capped at one or both ends with alkyl, carboxyl or amino groups, polydiallyldimethylammonium chlorides, water-soluble starches, water-soluble starch derivatives and/or water-soluble proteins. As a general rule the protective colloids have average molar masses M_{w} of more than 500, preferably of more than 1000 to not more than 100 000, usually up to 60 000. Apart from the specified protective colloids, suitability is possessed for example by water-soluble cellulose derivatives such as carboxymethylcellulose and graft polymers of vinyl acetate and/or vinyl propionate on polyethylene glycols and/or polysaccharides. Water-soluble starches, starch derivatives, and proteins are described for example in Römpp, Chemie Lexikon 9th Edition, Volume 5, page 3569, or in Houben-Weyl, Methoden der organischen Chemie, 4th Edition, Volume 14/2, Chapter IV, Conversion of cellulose and starch, by E. Husemann and R. Werner, pages 862-915, and also in Ullmanns Encyclopedia for Industrial Chemistry, 6th Edition, Volume 28, pages 533 ff. Under Polysaccharides.

Suitable protective colloids are, in particular, all kinds of water-soluble starch, including for example both amylose and amylopectin, natural starches, hydrophobically or hydrophilically modified starches, anionic starches, cationically modified starches, maltodextrins, degraded starches, it being possible to perform the starch degradation, for example, oxidatively, thermally, hydrolytically or enzymatically, and using both natural starches and modified starches. Further suitable protective colloids are dextrins and crosslinked water-soluble starches, which are water-swellable.

As a protective colloid it is preferred to use natural, water-soluble starches, which by starch digestion, for example, can be converted into a water-soluble form, and also to use anionically modified starches such as oxidized potato starch or cationically modified starches. Particular preference is given to using anionically modified starches which have been subjected to molecular weight reduction. The molecular weight reduction is preferably carried out enzymatically. All varieties of starch can be degraded enzymatically, such as natural starches or starch derivatives such as anionically or cationically modified, esterified, etherified or crosslinked starches. The natural starches may be obtained, for example, from potatoes, corn, wheat, rice, peas, tapioca or sorghum. Also of interest are starches which have an amylopectin content of >80% by weight, preferably >95% by weight, such as waxy corn starch or waxy potato starch.

A substituted starch is characterized more closely by specifying, for example, the fraction of cationic or anionic groups in the starch in question, by means of the degree of substitution (D.S.). It is usually 0.005 to 1.0 and is preferably situated in the range from 0.01 to 0.4.

Stabilization of emulsion polymers requires an aqueous starch solution. The average molar mass M_{w} of the starch is not more than 100 000. It is usually in the range from 1000 to 65 000, more particularly 2500 to 35 000. The average molar masses M_{w} of the starch can easily be determined by methods known to the skilled worker, as for example by means of gel permeation chromatography using a multiangle scattered light detector. The amount of degraded starch used for stabilization is for example 5% to 30% by weight, based on the sum of the monomers.

The enzymatic starch degradation can be performed separately, but preferably takes place as part of the preparation of aqueous polymer dispersions, by first degrading the starch by known methods in an aqueous medium in the presence of at least one enzyme, at a temperature for example in the range from 20 to 100° C., preferably 40 to 80° C. The amount of enzyme is for example 50 mg to 5.0 g/kg of a 5% strength aqueous starch solution, preferably 200 mg to 2.5 g/kg of 5% strength aqueous starch solution.

The enzymatic degradation of the starch is taken to the point, for example, where the viscosity of a 2.5% strength by weight aqueous solution of the enzymatically degraded starch is 10 to 1500 mPas, preferably 100 to 800 mPas (Brookfield viscometer, spindle 4, 20 rpm, 20° C.).

The enzymatic degradation of starches is state of the art. Enzymes are defined in EC classes by the International Union of Biochemistry and Molecular Biology: cf. Enzyme Nomenclature 1992 [Academic Press, San Diego, Calif., ISBN 0-12-227164-5 (hardback), 0-12-227165-3 (paperback)] with Supplement 1 (1993), Supplement 2 (1994), Supplement 3 (1995), Supplement 4 (1997), and Supplement 5 (in Eur. J. Biochem. 1994, 223, 1-5; Eur. J. Biochem. 1995, 232, 1-6; Eur. J. Biochem. 1996, 237, 1-5; Eur. J. Biochem. 1997, 250; 1-6, and Eur. J. Biochem. 1999, 264, 610-650). A continually updated list of the enzyme classes can be found on the internet at http://www.chem.qmul.ac.uk/iubmb/enzyme/.

Enzymes preferentially suitable are those from the subclass of the “Hydrolases EC 3.-.-.-”, the class of the “Glycosylases EC 3.2.-.-” or the sub-subclass “Glycosidases, able to hydrolyze O- and S-glycosidic compounds EC 3.2.1.-”. Examples of those suitable include α-amylase EC 3.2.1.1, β-amylase EC 3.2.1.2, γ-amylase EC 3.2.1.3, and pullulanase EC 3.2.1.41.

When the starch has been degraded to the desired molar mass, an acid is added to the aqueous solution of the degraded starch in order to destroy the enzyme and so to prevent further starch degradation. The amount of acid is for example 0.1% to 20% by weight, preferably 0.5% to 10% by weight, based on the starch used. Usually glacial acetic acid is used to halt the enzymatic starch degradation. Alternatively an acid comprising a phosphorus atom in its molecule can be used, such as phosphoric acid, phosphonic acid, phosphinic acid, peroxophosphoric acid, hypodiphosphonic acid, diphosphonic acid, hypodiphosphoric acid, diphosphoric acid, peroxodiphosphoric acid, polyphosphoric acid, metaphosphoric acid, nitrilotris(methylenetriphosphonic acid), ethylenediaminetetrakis(methylenetetraphosphonic acid), diethylenetriamine-pentakis(methylenephosphonic acid) and/or polyvinylphosphonic acid.

Particularly preferred dispersion stabilizers are combinations of at least one surfactant and of at least one degraded natural starch or of at least one water-soluble cationic or anionic starch and also mixtures of at least one surfactant and a dispersant comprising a condensate of naphthalenesulfonic acid and formaldehyde. The condensates of naphthalenesulfonic acid and formaldehyde may where appropriate also have been modified by condensative incorporation of urea. The condensates can be used in the form of the free acids and also in partially or fully neutralized form. Suitable neutralizing agents are preferably aqueous sodium or potassium hydroxide solution, ammonia, sodium hydrogen carbonate, sodium carbonate or potassium carbonate. Ligninsulfonic acid or salts thereof are also suitable dispersants. Besides the stated neutralizing agents for naphthalenesulfonic acid, calcium hydroxide and calcium oxide are also suitable for partial or complete neutralization of ligninsulfonic acid.

The polymerization of the monomers (a) to (d) is accomplished in the manner of an emulsion polymerization, i.e., the monomers for polymerization are present as an aqueous emulsion in the polymerization mixture. The monomer emulsions are stabilized using the dispersion stabilizers described above.

The monomers can be introduced as an initial charge to the reactor before the beginning of the polymerization or can be added in one or more portions or continuously to the reaction mixture and/or to the aqueous mixture of a dispersion stabilizer under polymerization conditions. For example, the major amount of the monomers, more particularly at least 80% and with particular preference the total amount, can be introduced as an initial charge to the polymerization vessel, together with the dispersion stabilizer, and immediately thereafter the polymerization can be commenced by the addition of a polymerization initiator. Another process variant involves first introducing a portion (e.g., 5% to 25%) of the monomers or of the monomer emulsion and a portion of the dispersion stabilizer as an initial charge to the polymerization reactor, commencing the polymerization by adding an initiator, and supplying the remaining amount of monomers or monomer emulsion and, if appropriate, dispersion stabilizer to the reactor continuously or in portions, and completing the polymerization of the monomers. With this process variant, for example, some or all of the polymerization initiator can be introduced as an initial charge to the reactor, or metered into the reactor separately from the remaining monomers or monomer emulsion.

The initiators that are suitable for emulsion polymerization are in principle all of the polymerization initiators typically used that trigger a free-radical polymerization of ethylenically unsaturated monomers. They include, for example, azo compounds such as 2,2′-azobisisobutyronitrile, 2,2′-azobis(2-methylbutyronitrile), 2,2′-azobis[2-methyl-N-(-2-hydroxyethyl)propionamide], 1,1′-azobis(1-cyclohexanecarbonitrile), 2,2′-azobis(2,4-dimethylvaleronitrile), 2,2′-azobis(N,N′-dimethyleneisobutyroamidine) dihydrochloride, and 2,2′-azobis(2-amidinopropane) dihydrochloride, organic or inorganic peroxides such as diacetyl peroxide, di-tert-butyl peroxide, diamyl peroxide, dioctanoyl peroxide, didecanoyl peroxide, dilauroyl peroxide, dibenzoyl peroxide, bis(o-tolyl) peroxide, succinyl peroxide, tert-butyl peracetate, tert-butyl permaleate, tert-butyl perisobutyrate, tert-butyl perpivalate, tert-butyl peroctoate, tert-butyl perneodecanoate, tert-butyl perbenzoate, tert-butyl peroxide, tert-butyl hydroperoxide, cumene hydroperoxide, tert-butyl peroxy-2-ethylhexanoate and diisopropyl peroxydicarbamate, salts of peroxodisulfuric acid, and redox initiator systems.

For the polymerization it is preferred to use a redox initiator system, more particularly a redox initiator system comprising as its oxidant a salt of peroxodisulfuric acid, hydrogen peroxide, or an organic peroxide such as tert-butyl hydroperoxide. As reductants the redox initiator systems preferably comprise a sulfur compound, selected more particularly from sodium hydrogen sulfite, sodium hydroxymethanesulfinate, and the adduct of hydrogen sulfite with acetone. Further suitable reductants are phosphorus compounds such as phosphorous acid, hypophosphites and phosphinates, and also hydrazine or hydrazine hydrate, and ascorbic acid. Redox initiator systems may further comprise a small added amount of redox metal salts such as iron salts, vanadium salts, copper salts, chromium salts or manganese salts, an example being the redox initiator system ascorbic acid/iron(II) sulfate/sodium peroxodisulfate. Particularly preferred redox initiator systems are acetone bisulfite adduct/organic hydroperoxide such as tert-butyl hydroperoxide; sodium disulfite (Na₂S₂O₅)/organic hydroperoxide such as tert-butyl hydroperoxide; sodium hydroxymethanesulfinate/organic hydroperoxide such as tert-butyl hydroperoxide; and ascorbic acid/hydrogen peroxide.

Typically the initiator is added in an amount of 0.02% to 2% by weight and more particularly 0.05% to 1.5% by weight, based on the amount of monomers. The optimum amount of initiator depends, of course, on the initiator system employed, and can be determined by the skilled worker in routine experiments. Some or all of the initiator can be included in the initial charge to the reaction vessel. Usually a portion of the initiator is included as an initial charge, together with a portion of the monomer emulsion, and the remaining initiator is added continuously or in portions along with the monomers, but separately from them.

Pressure and temperature are of minor importance to the conduct of the monomers' polymerization. The temperature depends, of course, on the initiator system employed. The optimum polymerization temperature can be determined by the skilled worker by means of routine experiments. Typically the polymerization temperature is situated within the range from 0 to 110° C., frequently in the range from 30 to 95° C. The polymerization is typically carried out under atmospheric or ambient pressure. Also, however, it can be carried out at an elevated pressure, of up to 10 bar, for example, or at a reduced pressure, of 20 to 900 mbar, for example, but usually at >800 mbar. The polymerization time is preferably 1 to 120 minutes, more particularly 2 to 90 minutes, and with particular preference 3 to 60 minutes, although longer or shorter polymerization times are possible.

Preference is given to polymerizing under what are known as “starved” conditions, i.e., conditions which as far as possible permit only minimal empty micelle formation or none at all. For this purpose either no further surface-active substance is added, or the amount of further surface-active substance added is so small that the water-insoluble monomer droplets are stabilized in the aqueous phase.

If a dispersion stabilizer is added additionally to stabilize the emulsion polymers that form in the emulsion polymerization, it is preferred to meter at least one surface-active substance in an amount, for example, of up to 5% by weight, e.g., 0.1% to 5% by weight, based on the monomers for polymerization. Surface-active substances, as well as the nonionic surface-active substances, include, in particular, anionic emulsifiers, examples being alkyl sulfates, alkylsulfonates, alkylarylsulfonates, alkyl ether sulfates, alkylaryl ether sulfates, anionic starch, sulfosuccinates such as sulfosuccinic monoesters and sulfosuccinic diesters, and alkyl ether phosphates, and also, furthermore, cationic emulsifiers.

The properties of the polymers can be modified by carrying out the emulsion polymerization, if appropriate, in the presence of at least one polymerization regulator. Examples of polymerization regulators are organic compounds comprising sulfur in bound form, such as dodecyl mercaptan, thiodiglycol, ethylthioethanol, di-n-butyl sulfide, di-n-octyl sulfide, diphenyl sulfide, diisopropyl disulfide, 2-mercaptoethanol, 1,3-mercaptopropanol, 3-mercaptopropane-1,2-diol, 1,4-mercaptobutanol, thioglycolic acid, 3-mercaptopropionic acid, mercaptosuccinic acid, thioacetic acid, and thiourea, aldehydes such as formaldehyde, acetaldehyde, and propionaldehyde, organic acids such as formic acid, sodium formate or ammonium formate, alcohols such as, more particularly, isopropanol, and phosphorus compounds such as sodium hypophosphite. If a regulator is used in the polymerization the amount used in each case is for example 0.01% to 5%, preferably 0.1% to 1% by weight, based on the monomers used in the polymerization. Polymerization regulators and crosslinkers can be used jointly in the polymerization. In that way it is possible to exert control over the rheology, for example, of the resultant polymer dispersions.

The polymerization is generally carried out at pH levels of 2 to 9, preferably in the weakly acidic range at pH levels of 3 to 5.5. The pH can be adjusted to the desired level prior to or during the polymerization, using typical acids such as hydrochloric acid, sulfuric acid or acetic acid, or else using bases such as aqueous sodium or potassium hydroxide solution, ammonia, ammonium carbonate, etc. Preferably the dispersion is adjusted to a pH of between 5 and 7 after the end of the polymerization, using aqueous sodium or potassium hydroxide solution or ammonia.

In order to remove the residual monomers from the polymer dispersion as far as possible, the polymerization proper is advantageously followed by postpolymerization. For this purpose, after the end of the main polymerization, an initiator from the group consisting of hydrogen peroxide, peroxides, hydroperoxides, and/or azo initiators, for example, is added to the polymer dispersion. The combination of initiators with suitable reductants, such as ascorbic acid or sodium bisulfite, for example, is likewise possible. Preference is given to using oil-soluble initiators of sparing water solubility, examples being typical organic peroxides such as dibenzoyl peroxide, di-tert-butyl peroxide, tert-butyl hydroperoxide, cumyl hydroperoxide or biscyclohexyl peroxydicarbonate. For postpolymerization the reaction mixture is heated to a temperature, for example, corresponding to the temperature at which the main polymerization has been carried out, or up to 20° C. higher, preferably up to 10° C. higher. The main polymerization is over when the polymerization initiator has been consumed or when the monomer conversion is for example at least 98%, preferably at least 99.5%. Postpolymerization is preferably carried out using tert-butyl hydroperoxide. The polymerization is carried out, for example, in a temperature range from 40 to 100° C., usually 50 to 95° C.

Polymer dispersions comprise dispersed particles having an average size of for example 20 to 500 nm, preferably 40 to 150 nm. The average particle size can be determined by methods known to the skilled worker, such as, for example, laser correlation spectroscopy, ultracentrifugation or CHDF (capillary hydrodynamic fractionation). A further measure of the size of the dispersed polymer particles is the LT (light transmittance). LT is determined by subjecting the particular polymer dispersion for analysis, in 0.1% by weight aqueous dilution, in a cuvette having an edge length of 2.5 cm, to measurement using light with a wavelength of 600 nm, and comparing the result with the corresponding transmittance of water under the same measurement conditions. The transmittance of water is specified as 100%. The finer the dispersion, the higher the LT measured by the method described above. From the measurements it is possible to calculate the average particle size; cf. B. Verner, M. Bárta, B. Sedlácek,

Tables of Scattering Functions for Spherical Particles, Prague, 1976, Edice Marco, Rada D-DATA, SVAZEK D-1.

The solids content of the polymer dispersion is for example 5% to 50% by weight and is preferably situated in the range from 15% to 40% by weight.

The aqueous polymer dispersions considered preferentially are obtainable by free-radically initiated emulsion copolymerization of
(a) styrene, methyl methacrylate and/or acrylonitrile,
(b) at least one C₁ to C₁₀ alkyl acrylate and/or at least one C₂ to C₁₀ alkyl methacrylate,
(c) pyrrolidonoethyl acrylate and/or pyrrolidonoethyl methacrylate, and
(d) if appropriate, other ethylenically unsaturated monomers.

They are preparable, for example, by free-radically initiated emulsion copolymerization, monomers copolymerized being
(a) 1% to 80% by weight of styrene, methyl methacrylate and/or acrylonitrile,
(b) 1% to 70% by weight of at least one C₁ to C₁₀ alkyl acrylate and/or at least one C₂ to C₁₀ alkyl methacrylate,
(c) 1% to 50% by weight of pyrrolidonoethyl acrylate and/or pyrrolidonoethyl methacrylate, and
(d) 0% to 20% by weight of at least one other ethylenically unsaturated monomer
   are copolymerized, the sum (a)+(b)+(c)+(d) being=100% by weight.

Preference in particular is given to those polymer dispersions obtainable by free-radically initiated emulsion polymerization of
(a) 20% to 70% by weight of styrene and/or acrylonitrile,
(b) 10% to 60% by weight of at least one C₁ to C₁₀ alkyl acrylate and/or at least one C₂ to C₁₀ alkyl methacrylate,
(c) 2% to 35% by weight of pyrrolidonoethyl acrylate and/or pyrrolidonoethyl methacrylate, and
(d) 0% to 10% by weight of at least one other ethylenically unsaturated monomer
   are copolymerized, the sum (a)+(b)+(c)+(d) being=100% by weight.

Particular preference is given to aqueous dispersions obtainable by carrying out the emulsion polymerization of the monomers (a), (b), and (c) and, if appropriate, (d) in the presence of a cationically or anionically modified starch, a degraded natural starch or a degraded cationically or anionically modified starch. The emulsion polymerization is carried more particularly in the presence of an enzymatically degraded starch.

Particularly fine aqueous polymer dispersions are obtained when the emulsion polymerization is carried out in the presence of an emulsifier mixture composed of a surfactant and an enzymatically degraded starch or a cationically or anionically modified starch.

The invention further provides for the use of aqueous dispersions obtainable by free-radically initiated emulsion polymerization of
(a) styrene, acrylonitrile, methacrylonitrile and/or methyl methacrylate,
(b) at least one C₁ to C₁₈ alkyl acrylate and/or at least one C₂ to C₁₈ alkyl methacrylate,
(c) at least one acrylic ester of an N-hydroxyalkylated lactam and/or at least one methacrylic ester of an N-hydroxyalkylated lactam, and
(d) if appropriate, other ethylenically unsaturated monomers, and/or of polymers which comprise in copolymerized form at least one acrylic ester of an N-hydroxyalkylated lactam and/or at least one methacrylic ester of an N-hydroxyalkylated lactam,
   for treating the surface of paper and of paper products.

As the treatment composition it is preferred to employ an aqueous dispersion obtainable by emulsion polymerization of
(a) 1% to 80% by weight of styrene and/or acrylonitrile,
(b) 1% to 70% by weight of at least one C₁ to C₁₀ alkyl acrylate and/or at least one C₂ to C₁₀ alkyl methacrylate,
(c) 1% to 50% by weight of pyrrolidonoethyl acrylate and/or pyrrolidonoethyl methacrylate, and
(d) 0% to 20% by weight of at least one other ethylenically unsaturated monomer,
   the sum (a)+(b)+(c)+(d) being=100% by weight.

Further treatment compositions considered preferentially are aqueous solutions of a homopolymer of pyrrolidonoethyl acrylate and/or pyrrolidonoethyl methacrylate and also water-soluble copolymers thereof, examples being aqueous solutions of a copolymer of
(i) pyrrolidonoethyl acrylate and/or pyrrolidonoethyl methacrylate and
(ii) acrylamide.

The water-soluble homopolymers and copolymers of pyrrolidonoethyl acrylate and/or pyrrolidonoethyl methacrylate can be prepared by methods known from the prior art cited at the outset (cf. in particular DE-A 20 48 312), as for example by methods of free-radically initiated polymerization, more particularly of solution polymerization. In the present context the polymers are termed water-soluble when dissolution of the polymer in water at a temperature of 20° C. is at least 5 g/l, preferably at least 10 g/l, and more particularly at least 20 g/l.

The solution polymerization can be carried out either as a batch process or in the form of a feed process, including monomer feed, staged procedures and gradient procedures. Preference is generally given to the feed process, in which, if appropriate, a portion of the polymerization mixture is introduced as an initial charge and is heated to the polymerization temperature, and then the remainder of the polymerization mixture, typically via one or more spatially separate feed streams, is supplied to the polymerization zone continuously, in stages or under a concentration gradient, during which the polymerization is maintained.

The solution polymers are prepared preferably in solvents such as water, methanol, ethanol, isopropanol, ethyl acetate, butyl acetate, methyl ethyl ketone, acetone, toluene or mixtures of these solvents. The amounts of monomers and solvents are advantageously selected so as to give solutions with a strength of 30% to 70% by weight. The polymerization takes place typically at temperatures from 50 to 140° C. under atmospheric pressure or under the autogenous pressure.

As initiators for the free-radical polymerization it is possible to employ the water-soluble and water-insoluble peroxo compounds and/or azo compounds that are customary for this purpose, examples being alkali metal or ammonium peroxydisulfates, dibenzoyl peroxide, tert-butyl perpivalate, tert-butyl per-2-ethyl hexanoate, di-tert-butyl peroxide, tert-butyl hydroperoxide, azobisisobutyronitrile, azobis(2-amidinopropane) dihydrochloride or 2,2′-azo-bis(2-methylbutyronitrile). Also suitable are initiator mixtures or redox initiator systems such as ascorbic acid/iron(II) sulfate/sodium peroxodisulfate, tert-butyl hydroperoxide/sodium sulfite, tert-butyl hydroperoxide/sodium hydroxymethanesulfinate. The initiators can be used in the typical amounts, as for example in amounts of from 0.05% to 5% by weight, based on the amount of the monomers to be polymerized.

In order to vary the molar mass of the polymers, the use of a regulator may be appropriate. Examples of suitable regulators include aldehydes such as formaldehyde, acetaldehyde, propionaldehyde, n-butyraldehyde and isobutyraldehyde, formic acid, ammonium formate, hydroxylammonium sulfate and hydroxylammonium phosphate. Additionally it is possible to use regulators which comprise sulfur in organically bound form, such as di-n-butyl sulfide, di-n-octyl sulfide, diphenyl sulfide, etc., or regulators which comprise sulfur in the form of SH groups, such as n-butyl mercaptan, n-hexyl mercaptan or n-dodecyl mercaptan. Also suitable are water-soluble polymerization regulators containing sulfur, such as hydrogen sulfites and disulfites. Further suitable regulators include allyl compounds, such as allyl alcohol or allyl bromide, benzyl compounds, such as benzyl chloride, or alkyl halides, such as chloroform or tetrachloromethane.

The solutions formed in the polymerization may if appropriate be converted by solvent exchange into an aqueous solution. It is preferred to carry out a steam distillation until a temperature of about 100° C. has been reached at the top of the column.

The solutions formed in the polymerization may if appropriate be converted into solid powders by means of a prior-art drying method. Examples of preferred methods include spray drying, fluid-bed spray drying, roll drying, and belt drying. Likewise possible for application are freeze drying and freeze concentration. The solvent, if desired, can also be removed by typical methods, wholly or partly, such as by distillation under reduced pressure, for example.

The treatment of paper and of paper products such as paperboard and cardboard with the dispersions of the invention and/or with the abovementioned water-soluble polymers comprising in copolymerized form at least one (meth)acrylic ester of an N-hydroxyalkylated lactam results in an improvement in the inkjet printability of the papers and paper products thus treated.

The invention accordingly also provides an inkjet paper obtainable by treating at least one surface of a paper or of a paper product with an aqueous dispersion obtainable by free-radically initiated emulsion polymerization of
(a) styrene, acrylonitrile, methacrylonitrile and/or methyl methacrylate,
(b) at least one C₁ to C₁₈ alkyl acrylate and/or at least one C₂ to C₁₈ alkyl methacrylate,
(c) at least one acrylic ester of an N-hydroxyalkylated lactam and/or at least one methacrylic ester of an N-hydroxyalkylated lactam, and
(d) if appropriate, other ethylenically unsaturated monomers
   and/or with polymers which comprise in copolymerized form at least one acrylic ester of an N-hydroxyalkylated lactam and/or at least one methacrylic ester of an N-hydroxyalkylated lactam.

Examples of varieties of paper whose inkjet printability can be improved include all graphics papers, natural paper, coated papers or paperboard and cardboard. They are treated, for example, by applying an aqueous dispersion or solution of the above-described polymers to the paper surface and drying the paper thus treated. Surface application may take place with the aid, for example, of a size press, a film press, a spray installation, a coating assembly or a paper calender. Just the top face or the bottom face of a piece of paper can be coated fully with the preparation solution or dispersion, or else both sides can be impregnated therewith simultaneously or in succession. The polymers are applied in an amount, for example, of 0.01 to 5 g/m² to the paper surface.

The percentages in the examples are by weight unless the context indicates otherwise.

The K values were determined by the method of H. Fikentscher, Cellulose-Chemie, vol. 13, 58-64 and 71-74 (1932) in 1% strength aqueous or 1% strength ethanolic solution at a temperature of 25° C.

### EXAMPLES

### 1. Emulsion Polymerization

### Example 1

A 2 l flask with ground glass joints, stirrer, and internal temperature measurement was charged with 73.17 g of a cationized potato starch (Südstärke, D.S.=0.088). With stirring, 280 g of demineralized water, 0.47 g of α-amylase (1% form, Novo Nordisk) and 0.8 g of calcium acetate hydrate, 25% form, were added. The mixture was heated to 85° C. with stirring. Thereafter 8.07 g of α-amylase (1% form, Novo Nordisk) were added and the mixture was stirred for a further 30 minutes. Subsequently 4.0 g of glacial acetic acid and 0.8 g of iron(II) sulfate heptahydrate in the form of a 10% strength aqueous solution were added. Over the course of 30 minutes 3.73 g of an 18% strength hydrogen peroxide solution were run in. Then a monomer feed was commenced which consisted of 33.33 g of demineralized water, 0.15 g of a mixture of the Na salt of alkanesulfonates having an average chain length of C15 (in 40% form), 93.1 g of styrene, 39.9 g of n-butyl acrylate and 7.0 g of pyrrolidono-N-ethyl methacrylate. The feed time for the monomer feed was 120 minutes. At the same time a feed was commenced of 33.6 g of 18% strength hydrogen peroxide solution, over a period of 150 minutes. The mixture was postpolymerized for 30 minutes, after which 4 g of tert-butyl hydroperoxide in 10% form were added and the mixture was cooled to 60° C. Subsequently a further 5.7 g of tert-butyl hydroperoxide in 10% form were added, and the reaction mixture was stirred at 60° C. for 30 minutes more. After cooling to 30° C. it was neutralized with 23 g of sodium hydroxide (25% strength aqueous solution).

This gave a fine polymer dispersion having a solids content of 29.3% and an average particle size of 73 nm.

### Example 2

A 2 l flask with ground glass joints, stirrer, and internal temperature measurement was charged with 73.17 g of a cationized potato starch (Südstärke, ds=0.088). With stirring, 280 g of demineralized water, 0.47 g of α-amylase (1% form, Novo Nordisk) and 0.8 g of calcium acetate hydrate, 25% form, were added. The mixture was heated to 85° C. with stirring. Thereafter 8.07 g of α-amylase (1% form, Novo Nordisk) were added and the mixture was stirred for a further 30 minutes. Subsequently 4.0 g of glacial acetic acid and 0.8 g of iron(II) sulfate heptahydrate in 10% form were added. Over the course of 30 minutes 3.73 g of an 18% strength hydrogen peroxide solution were run in. Then a monomer feed was commenced which consisted of 33.33 g of demineralized water, 0.15 g of a mixture of the Na salt of alkanesulfonates having an average chain length of C15 (in 40% form), 88.2 g of styrene, 37.8 g of n-butyl acrylate and 14 g of pyrrolidono-N-ethyl methacrylate. The feed time for the monomer feed was 120 minutes. At the same time a feed was commenced of 33.6 g of 18% strength hydrogen peroxide solution, over a period of 150 minutes. The mixture was postpolymerized for 30 minutes, after which 4 g of tert-butyl hydroperoxide in 10% form were added and the mixture was cooled to 60° C. Subsequently a further 5.7 g of tert-butyl hydroperoxide in 10% form were added, and the reaction mixture was stirred at 60° C. for 30 minutes more. After cooling to 30° C. it was neutralized with 23 g of sodium hydroxide (25% form).

This gave a fine polymer dispersion having a solids content of 30.4% and an average particle size of 92 nm.

### Example 3

A 2 l flask of ground glass joints, stirrer, and internal temperature measurement was charged with 224.67 g of distilled water, 49.83 g of a maltodextrin starch (Cerestar) and 0.58 g of Dowfax 2A1. 10% of the initiator solution (23.14 g of a 7% strength sodium peroxodisulfate solution) and 10% of the monomer solution, consisting of 151.83 g of distilled water, 1.7 g of arylsulfonate, 4.99 g of acrylic acid, 102.17 g of styrene, 130.57 g of n-butyl acrylate and 12.25 g of pyrrolidono-N-ethyl methacrylate, were added. The mixture was heated to 90° C. with stirring and stirred at that temperature for 15 minutes. Then the remaining monomer feed was commenced, over the course of 180 minutes, and the remaining initiator feed, over the course of 210 minutes. After the end of the feeds the mixture was stirred at 90° C. for 60 minutes, then cooled to 40° C., and 2.62 g of 10% strength hydrogen peroxide solution and also a mixture of 2.68 g of ascorbic acid solution (10% strength) and 0.31 g of iron(II) sulfate solution (1% strength aqueous solution) were added. The mixture was postpolymerized for 30 minutes and then partially neutralized with 2.95 g of sodium hydroxide (25% strength aqueous solution). This gave a polymer dispersion having a solids content of 38.3% and an average particle size of 155 nm.

### Example 4

A 2 l flask of ground glass joints, stirrer, and internal temperature measurement was charged with 224.67 g of distilled water, 49.83 g of a maltodextrin starch (Cerestar) and 0.58 g of Dowfax 2A1. 10% of the initiator solution (23.14 g of a 7% strength sodium peroxodisulfate solution) and 10% of the monomer solution, consisting of 151.83 g of distilled water, 1.7 g of arylsulfonate, 4.99 g of acrylic acid, 96.8 g of styrene, 123.7 g of n-butyl acrylate and 24.5 g of pyrrolidono-N-ethyl methacrylate, were added. The mixture was heated to 90° C. with stirring and stirred at that temperature for 15 minutes. Then the remaining monomer feed was commenced, over the course of 180 minutes, and the remaining initiator feed, over the course of 210 minutes. After the end of the feeds the mixture was stirred at 90° C. for 60 minutes, then cooled to 40° C., and 2.62 g of 10% strength hydrogen peroxide solution and also a mixture of 2.68 g of ascorbic acid solution (10% strength) and 0.31 g of iron(II) sulfate solution (1% strength aqueous solution) were added. The mixture was postpolymerized for 30 minutes and then partially neutralized with 2.95 g of sodium hydroxide (25% strength aqueous solution). This gave a polymer dispersion having a solids content of 38.0% and an average particle size of 156 nm.

### Example 5

A 2 l flask with ground glass joints, stirrer, and internal temperature measurement was charged with 73.17 g of a cationized potato starch (Südstärke, ds=0.088). With stirring, 280 g of demineralized water, 0.47 g of α-amylase (1% form, Novo Nordisk) and 0.8 g of calcium acetate hydrate, 25% form, were added. The mixture was heated to 85° C. with stirring. Thereafter 8.07 g of α-amylase (1% form, Novo Nordisk) were added and the mixture was stirred for a further 30 minutes. Subsequently 4.0 g of glacial acetic acid and 0.8 g of iron(II) sulfate heptahydrate in the form of a 10% strength aqueous solution were added and over the course of 30 minutes 3.73 g of an 18% strength hydrogen peroxide solution were run in. Then a monomer feed was commenced which consisted of 33.33 g of demineralized water, 0.15 g of a mixture of the Na salt of alkanesulfonates having an average chain length of C15 (in 40% form), 100.8 g of methyl methacrylate, 25.2 g of n-butyl acrylate and 14 g of pyrrolidono-N-ethyl methacrylate. The feed time for the monomer feed was 120 minutes. At the same time a feed was commenced of 33.6 g of 18% strength hydrogen peroxide solution, over a period of 150 minutes. The mixture was postpolymerized for 30 minutes, after which 4 g of tert-butyl hydroperoxide in 10% form were added and the mixture was cooled to 60° C. Subsequently a further 5.7 g of tert-butyl hydroperoxide in 10% form were added, and the reaction mixture was stirred at 60° C. for 30 minutes more. After cooling to 30° C. it was neutralized with 23 g of sodium hydroxide (25% strength aqueous solution). This gave a fine polymer dispersion having a solids content of 29.9% and an average particle size of 110 nm.

### Example 6

A 2 l flask with ground glass joints, stirrer, and internal temperature measurement was charged with 73.17 g of a cationized potato starch (Avebe, D.S.=0.047). With stirring, 280 g of demineralized water, and 0.8 g of calcium acetate hydrate, 25% form, were added. The mixture was heated to 85° C. with stirring. Thereafter 5.84 g of α-amylase (1% form, Novo Nordisk) were added and the mixture was stirred for a further 30 minutes. Subsequently 4.0 g of glacial acetic acid and 0.8 g of iron(II) sulfate heptahydrate in 10% form were added and over the course of 20 minutes 3.13 g of an 18% strength hydrogen peroxide solution were run in. Then a monomer feed was commenced which consisted of 33.33 g of demineralized water, 0.17 g of a mixture of the Na salt of alkanesulfonates having an average chain length of C15 (in 40% form), 68.4 g of acrylonitrile, 51.8 g of n-butyl acrylate and 21.2 g of pyrrolidono-N-ethyl acrylate. The feed time for the monomer feed was 120 minutes. At the same time a feed was commenced of 33.6 g of 18% strength hydrogen peroxide solution, over a period of 150 minutes. The mixture was postpolymerized for 30 minutes, and the mixture was cooled to 60° C. Subsequently a further 7.2 g of tert-butyl hydroperoxide in 10% form were added, and the reaction mixture was stirred at 50° C. for 30 minutes more. This gave a fine polymer dispersion having a solids content of 31.1% and an average particle size of 89 nm.

### Example 7

A 2 l flask with ground glass joints, stirrer, and internal temperature measurement was charged with 73.17 g of a cationized potato starch (Südstärke, D.S.=0.088). With stirring, 280 g of demineralized water, 0.47 g of α-amylase (1% form, Novo Nordisk) and 0.8 g of calcium acetate hydrate, 25% form, were added. The mixture was heated to 85° C. with stirring. Thereafter 8.07 g of α-amylase (1% form, Novo Nordisk) were added and the mixture was stirred for a further 30 minutes. Subsequently 4.0 g of glacial acetic acid and 0.8 g of iron(II) sulfate heptahydrate in the form of a 10% strength aqueous solution were added. Over the course of 30 minutes 3.73 g of an 18% strength hydrogen peroxide solution were run in. Then a monomer feed was commenced which consisted of 33.33 g of demineralized water, 0.15 g of a mixture of the Na salt of alkanesulfonates having an average chain length of C15 (in 40% form), 93.1 g of styrene, 39.9 g of n-butyl acrylate and 7.0 g of pyrrolidono-N-ethyl acrylate. The feed time for the monomer feed was 120 minutes. At the same time a feed was commenced of 33.6 g of 18% strength hydrogen peroxide solution, over a period of 150 minutes. The mixture was postpolymerized for 30 minutes, after which 4 g of tert-butyl hydroperoxide in 10% form were added and the mixture was cooled to 60° C. Subsequently a further 5.7 g of tert-butyl hydroperoxide in 10% form were added, and the reaction mixture was stirred at 60° C. for 30 minutes more. After cooling to 30° C. it was neutralized with 23 g of sodium hydroxide (25% strength aqueous solution). This gave a fine polymer dispersion having a solids content of 29.9% and an average particle size of 77 nm.

### Comparative Example 1

A 2 l flask of ground glass joints, stirrer, and internal temperature measurement was charged with 224.67 g of distilled water, 49.83 g of a maltodextrin starch (Cerestar) and 0.58 g of Dowfax 2A1. 10% of the initiator solution (23.14 g of a 7% strength sodium peroxodisulfate solution) and 10% of the monomer solution, consisting of 151.83 g of distilled water, 1.7 g of arylsulfonate, 4.99 g of acrylic acid, 107.55 g of styrene and 137.45 g of n-butyl acrylate were added. The mixture was heated to 90° C. with stirring and stirred at that temperature for 15 minutes. Then the remaining monomer feed was commenced, over the course of 180 minutes, and the remaining initiator feed, over the course of 210 minutes. After the end of the feeds the mixture was stirred at 90° C. for 60 minutes. It was then cooled to 40° C., and 2.62 g of 10% strength hydrogen peroxide solution and also a mixture of 2.68 g of ascorbic acid solution (10% strength) and 0.31 g of iron(II) sulfate solution (1% strength aqueous solution) were added. The mixture was postpolymerized for 30 minutes and then partially neutralized with 2.95 g of sodium hydroxide (25% strength aqueous solution). This gave a polymer dispersion having a solids content of 38.1% and an average particle size of 167 nm.

### 2. Solution Polymerization

The polymers were prepared using a 500 ml reaction vessel with process-controlled oil bath, anchor stirrer, and thermometer. The vessel has connections for a feed, a reflux condenser, and nitrogen introduction.

### Solution Polymer 1

78.95 g of pyrrolidonoethyl methacrylate, 6.74 g of water and 120.75 g of ethanol were charged to the reaction vessel and heated to an internal temperature of 75° C. Then 4.53 g of feed stream 1 were added, consisting of 0.3 g of Wako V 50 (2,2′-azobis-(2-amidinopropane) dihydrochloride) in 45.0 g of water. After 30 minutes the remainder of feed stream 1 was run in over the course of 3 hours and polymerization was continued for two hours. After the end of the polymerization the solvent was replaced with water by steam distillation.

This gave an aqueous polymer solution having a solids content of 24.1%. The polymer gave a Fikentscher K value of 30.2 in 1% strength aqueous solution.

### Solution Polymer 2

77.32 g of pyrrolidonoethyl methacrylate, 41.5 g of water and 85.99 g of ethanol were charged to the reaction vessel and heated to an internal temperature of 75° C. Then 4.52 g of feed stream 1 were added, consisting of 0.19 g of Wako V 50 (2,2′-azobis-(2-amidinopropane) dihydrochloride) in 45.0 g of water. After 30 minutes the remainder of feed stream 1 was run in over the course of 3 hours and polymerization was continued for two hours. After the end of the polymerization the solvent was replaced with water by steam distillation.

This gave an aqueous polymer solution having a solids content of 30.9%. The polymer gave a Fikentscher K value of 46 in 1% strength aqueous solution.

### Solution Polymer 3

77.32 g of pyrrolidonoethyl methacrylate and 127.49 g of water were charged to the reaction vessel and heated to an internal temperature of 75° C. Then 4.52 g of feed stream 1 were added, consisting of 0.19 g of Wako V 50 (2,2′-azobis-(2-amidinopropane) dihydrochloride) in 45.0 g of water. After 30 minutes the remainder of feed stream 1 was run in over the course of 3 hours and polymerization was continued for two hours.

This gave an aqueous polymer solution having a solids content of 32.7%. The polymer gave a Fikentscher K value of 71.7 in 1% strength aqueous solution.

### Solution Polymer 4

68.18 g of pyrrolidonoethyl methacrylate, 15 g of acrylamide and 128.82 g of water were charged to the reaction vessel and heated to an internal temperature of 85° C. Then 4.8 g of feed stream 1 were added, consisting of 3.0 g of Wako V 50 (2,2′-azobis-(2-amidinopropane) dihydrochloride) in 45.0 g of water. After 10 minutes the remainder of feed stream 1 was run in over the course of 2 hours and polymerization was continued for two hours. This gave an aqueous polymer solution having a solids content of 30.7%. The polymer gave a Fikentscher K value of 34.2 in 1% strength aqueous solution.

### 3. Treatment of Paper to Improve Inkjet Printability

The polymers specified in table 1 were tested at improving the inkjet printability of paper.

### Test Methods:

The degree of sizing was determined by the Cobb60 method in accordance with DIN EN 20 535. The ink flotation time (IFT) was carried out according to DIN 53 126 using a blue ink for paper testing. The color density of the inkjet-printed papers was measured using a Gretag densitometer in accordance with DIN 16536. The line widths were measured by image analysis using a commercially available system. The water resistance of the inkjet prints was determined by comparing the optical density before and after water exposure of the printed papers.

Application of the synthetic polymers in combination with starch to paper.

A commercially available oxidatively degraded potato starch was dissolved with heating at 95° C. for at least 20 minutes. This starch solution was then admixed with the polymer dispersion under test, in such a way as to achieve the concentrations specified in table 1 (the figures relate in each case to solid quantities). The mixture of starch solution and polymer or the polymer solution alone was subsequently applied using a sizing press to a paper having a basis weight of 80 g/m², slightly presized in the stock with AKD (alkyldiketene), at a temperature of 50° C. The total absorption of the preparation was in the range of 40-45%. The papers treated in this way were subsequently contact-dried at 90° C., acclimatized at 50% humidity for 24 hours, and then subjected to the tests.

TABLE 1
Composition of sizing press formulations

| | | Starch | Polymer dispersion |
|---|---|---|---|
| Examples | Products from | (g/l) | (g/l) |
| 8 | Example 1 | 80 | 2 |
| 9 | Example 2 | 80 | 2 |
| 10 | Example 3 | 80 | 2 |
| 11 | Example 4 | 80 | 2 |
| 12 | Example 5 | 80 | 2 |
| 13 | Example 6 | 80 | 2 |
| 14 | Example 7 | 80 | 2 |
| Comp. ex. 2 | Comparative example 1 | 80 | 2 |
| Comp. ex. 3 | Commercial sizing | 80 | 2 |
| | composition | | |
| | (Basoplast ® 250D) | | |

The papers thus produced were printed using a commercial inkjet printer from Hewlett Packard (HP 5740) and evaluated for optical density and line quality. The results are specified in table 2.

TABLE 2

| Printed paper | | | | | |
|---|---|---|---|---|---|
| obtained | | | Color | Color | |
| according to | Cobb 60 | IFT | density, | density, | Line width |
| example | [g/m²] | [min] | black | cyan | [μm] |
| 8 | 28 | 28 | 1.81 | 1.17 | 434 |
| 9 | 29 | 27 | 1.92 | 1.19 | 426 |
| 10 | 35 | 21 | 1.85 | 1.18 | 412 |
| 11 | 34 | 21 | 1.93 | 1.21 | 401 |
| 12 | 38 | 19 | 1.76 | 1.11 | 450 |
| 13 | 30 | 25 | 2.01 | 1.22 | 399 |
| 14 | 29 | 27 | 1.88 | 1.19 | 422 |
| Comp. ex. 2 | 30 | 20 | 1.69 | 1.06 | 456 |
| Comp. ex. .3 | 36 | 22 | 1.65 | 1.03 | 471 |

TABLE 3

| Printed paper obtained | Difference in color | Difference in color |
|---|---|---|
| according to example | density, black, in % | density, cyan, in % |
| 8 | 13.8 | 22.1 |
| 2 | 11.8 | 14.9 |
| 10 | 14.1 | 23.5 |
| 11 | 10.4 | 15.6 |
| 12 | 19.9 | 20.6 |
| 13 | 3.4 | 12.4 |
| 14 | 12.5 | 19.4 |
| Comp. ex. 2 | 43.7 | 36.8 |
| Comp. ex. 3 | 49.9 | 46.8 |

The papers produced were subsequently exposed to water (1 minute in distilled water at room temperature), and then dried, and again the color density was measured both in the black color field and in the cyan color field. The parameter stated is the difference in color density before and after water exposure, in percent, cf. table 3.

In a further series the solution polymers 1 to 4, in accordance with the composition of the sizing press formulation as specified in table 4, were applied to paper and dried.

TABLE 4

| | | | | Basoplast ® |
|---|---|---|---|---|
| Example | Solution polymer | Starch | Polymer | 250D |
| No. | employed No. | [g/l] | [g/l] | [g/l] |
| 15 | 1 | 80 | 5 | — |
| 16 | 2 | 80 | 5 | — |
| 17 | 3 | 80 | 5 | — |
| 18 | 4 | 80 | 5 | — |
| 19 | 1 | 80 | 1.5 | 2 |
| 20 | 2 | 80 | 1.5 | 2 |
| 21 | 3 | 80 | 1.5 | 2 |
| 22 | 4 | 80 | 1.5 | 2 |
| Comp. | Basoplast ® | 80 | — | 2 |
| example 4 | 250D | | | |

The papers thus produced were printed using a commercial inkjet printer from Hewlett Packard (HP 5740) and evaluated for optical density and line quality. The results are specified in table 5.

TABLE 5

| Printed paper | | | | | |
|---|---|---|---|---|---|
| obtained | | | Color | Color | |
| according to | Cobb 60 | IFT | density, | density, | Line width |
| example | [g/m²] | [min] | black | cyan | [μm] |
| 15 | 48 | 5 | 1.66 | 1.02 | 468 |
| 16 | 44 | 4 | 1.65 | 1.02 | 470 |
| 17 | 42 | 9 | 1.69 | 1.04 | 462 |
| 18 | 47 | 8 | 1.63 | 1.03 | 469 |
| 19 | 35 | 15 | 1.87 | 1.14 | 442 |
| 20 | 35 | 17 | 1.84 | 1.15 | 433 |
| 21 | 30 | 21 | 1.91 | 1.19 | 425 |
| 22 | 34 | 18 | 1.79 | 1.18 | 438 |
| Comp. ex. 4 | 36 | 22 | 1.65 | 1.03 | 471 |

The papers produced were subsequently exposed to water (1 minute in distilled water at room temperature), and then dried, and again the color density was measured both in the black color field and in the cyan color field. The parameter stated is the difference in color density before and after water exposure, in percent, cf. table 6.

TABLE 6

| Printed paper obtained | Difference in color | Difference in color |
|---|---|---|
| according to example | density, black, in % | density, cyan, in % |
| 15 | 25.6 | 24.6 |
| 16 | 28.1 | 27.8 |
| 17 | 21.3 | 19.5 |
| 18 | 24.8 | 21.8 |
| 19 | 18.9 | 15.9 |
| 20 | 16.8 | 14.7 |
| 21 | 13.1 | 12.6 |
| 22 | 17.8 | 15.2 |
| Comp. ex. 4 | 49.9 | 46.8 |

1. An aqueous dispersion of (meth)acrylic esters of polymers comprising N-hydroxyalkylated lactam units, wherein the aqueous dispersion is obtained by free-radically initiated emulsion polymerization of (meth)acrylic esters of N-hydroxyalkylated lactams and other ethylenically unsaturated monomers, wherein monomers copolymerized comprise
(a) at least one of styrene, acrylonitrile, methacrylonitrile and methyl methacrylate,
(b) at least one of C₁ to C₁₈ alkyl acrylate and C₂ to C₁₈ alkyl methacrylate,
(c) at least one of acrylic ester of an N-hydroxyalkylated lactam and methacrylic ester of an N-hydroxyalkylated lactam, and
(d) optionally, other ethylenically unsaturated monomers.

2. The aqueous dispersion according to claim 1, wherein the monomers copolymerized comprise
(a) at least one of styrene, methyl methacrylate and acrylonitrile,
(b) at least one of C₁ to C₁₀ alkyl acrylate and C₂ to C₁₀ alkyl methacrylate,
(c) at least one of pyrrolidonoethyl acrylate and pyrrolidonoethyl methacrylate, and
(d) optionally, other ethylenically unsaturated monomers.

3. The aqueous dispersion according to claim 1, wherein the monomers copolymerized have
(a) 1% to 80% by weight of at least one of styrene, methyl methacrylate and acrylonitrile,
(b) 1% to 70% by weight of at least one of C₁ to C₁₀ alkyl acrylate and C₂ to C₁₀ alkyl methacrylate,
(c) 1% to 50% by weight of at least one of pyrrolidonoethyl acrylate and pyrrolidonoethyl methacrylate, and
(d) 0% to 20% by weight of at least one other ethylenically unsaturated monomer wherein, the sum (a)+(b)+(c)+(d) is 100% by weight.

4. The aqueous dispersion according to claim 1, wherein the monomers copolymerized have
(a) 20% to 70% by weight of at least one of styrene and acrylonitrile,
(b) 10% to 60% by weight of at least one of C₁ to C₁₀ alkyl acrylate and C₂ to C₁₀ alkyl methacrylate,
(c) 2% to 35% by weight of at least one of pyrrolidonoethyl acrylate and pyrrolidonoethyl methacrylate, and
(d) 0% to 10% by weight of at least one other ethylenically unsaturated monomer wherein, the sum (a)+(b)+(c)+(d) is 100% by weight.

5. The aqueous dispersion according to claim 1, wherein the emulsion polymerization is carried out in the presence of a cationically or anionically modified starch, a degraded natural starch or a degraded cationically or anionically modified starch.

6. The aqueous dispersion according to claim 1, wherein the emulsion polymerization is carried out in the presence of an enzymatically degraded starch.

7. The aqueous dispersion according to claim 1, wherein the emulsion polymerization is carried out in the presence of an emulsifier mixture of a surfactant and an enzymatically degraded starch or a cationically or anionically modified starch.

8. A method, comprising applying to a surface of paper an aqueous dispersion obtained by free-radically initiated emulsion polymerization of at least one of polymers comprising
(a) at least one of styrene, acrylonitrile, methacrylonitrile and methyl methacrylate,
(b) at least one of C₁ to C₁₈ alkyl acrylate and C₂ to C₁₈ alkyl methacrylate,
(c) at least one of acrylic ester of an N-hydroxyalkylated lactam and methacrylic ester of an N-hydroxyalkylated lactam, and
(d) optionally, other ethylenically unsaturated monomers,
and polymers which comprise in copolymerized form at least one of acrylic ester of an N-hydroxyalkylated lactam and methacrylic ester of an N-hydroxyalkylated lactam.

9. The method according to claim 8, wherein the polymers are applied in an amount of 0.01 to 5 g/m² to the surface of paper.

10. The method according to claim 8, wherein the aqueous dispersion is obtained by emulsion polymerization of
(a) 1% to 80% by weight of at least one of styrene and acrylonitrile,
(b) 1% to 70% by weight of at least one of C₁ to C₁₀ alkyl acrylate and C₂ to C₁₀ alkyl methacrylate,
(c) 1% to 50% by weight of at least one of pyrrolidonoethyl acrylate and pyrrolidonoethyl methacrylate, and
(d) 0% to 20% by weight of at least one other ethylenically unsaturated monomer, wherein the sum (a)+(b)+(c)+(d) is 100% by weight.

11. The method according to claim 8, wherein the aqueous solution comprises a homopolymer of (meth)acrylic esters of N-hydroxyalkylated lactam units.

12. The method according to claim 8, wherein the aqueous solution comprises a homopolymer of at least one of pyrrolidonoethyl acrylate and pyrrolidonoethyl methacrylate.

13. The method according to claim 8, wherein the aqueous solution comprises a copolymer of
(i) at least one of pyrrolidonoethyl acrylate and pyrrolidonoethyl methacrylate and
(ii) acrylamide.

14. An inkjet paper obtained by treating at least one surface of a paper or of a paper product with an aqueous dispersion according to claim 1 or with polymers which comprise in copolymerized form at least one of acrylic ester of an N-hydroxyalkylated lactam and methacrylic ester of an N-hydroxyalkylated lactam.
